(19) United States
(12) Patent Application Publication
(10) Pub. No.: US 2024/0157731 A1
(43) Pub. Date: May 16, 2024

(54) REINFORCEMENT WIRE

(71) Applicant: SOCIETÀ INDUSTRIALE CREMONESE S.P.A., Pizzighettone, Cremona (IT)

(72) Inventors: Davide BOLGIAGHI, Abbiategrasso, Milano (IT); Enrique HERRERO ACERO, Tulln an der Donau (AT)

(21) Appl. No.: 18/548,527

(22) PCT Filed: Mar. 4, 2022
(86) PCT No.: PCT/EP2022/055621

§ 371 Date: Aug. 31, 2023

(30) Foreign Application Priority Data
Mar. 5, 2021 (EP) 21161000.1

(51) Int. Cl. B60C 9/00; D02G 3/36; D02G 3/48; D07B 1/00

(52) U.S. Cl. CPC B60C 9/005; B60C 9/0042; B60C 9/0064; D02G 3/36; D02G 3/48; D07B 1/005; B60C 9/0028; B60C 2009/0035; B60C 2009/0092; D07B 2201/2006; D07B 2201/2009; D07B 2201/2066; D07B 2201/2079; D07B 2201/209; D07B 2201/2092; D07B 2205/2039; D07B 2205/2046; D07B 2205/305; D07B 2205/3053; D07B 2205/3057; D07B 2501/2046; D10B 2331/021; D10B 2331/04; D10B 2505/022

(57) ABSTRACT

A composite wire has a thermoplastic core component and a sheath. The sheath includes at least two groups of reinforcement threads wrapped around the core component. The at least two groups of reinforcement threads form angles with the core component, with the overall sum of all angles which are essentially zero.

The application pertains to a composite wire for reinforcement purposes of elastomeric materials, e.g. in tires.

Tires made from elastomeric materials are an essential component of nearly all road vehicles and airplanes and for more than half a century such tires are much more than inflatable balloons of rubber. Tires are complex structures including sophisticated rubber blends and several entities of fiber reinforcements of different materials.

A typical tire comprises at least five different kinds of reinforcements. The bead area is reinforced by a bead reinforcement usually made of steel wire or steel cord. Directly underneath the tread there is located the so-called cap-ply. The tire belt is located underneath the cap-ply. Typically, the belt is a structure of steel cords and the backbone structure of the tire is formed by the so-called carcass which is usually a woven structure of textile cords.

The fifth component is the reinforcing fabric that embeds the bead and the bead filler, known to the skilled person as flipper (in case it is made of textile) or chafer (in case it is made of steel cord).

The use of steel cords and wires is common in tires for the sake of tire stability. Steel cords and wires show high compression resistance and flexural stiffness which have not been reached by textile cord structures for tire application so far. Steel cords and wires are furthermore used for economic reasons as they are cheaper compared to many high-tenacity textile materials.

However, the big disadvantage of the extensive use of steel cords and wires in tires is the high weight of these structures. A wider use of textile materials would lead to a significant reduction of weight and to an improvement of the rolling resistance and, as a consequence, to a significant decrease of fuel consumption of the corresponding vehicles.

It is, therefore, an object of the current application to provide a reinforcement suitable for use in pneumatic vehicle tires that is able to reduce the amount of steel in tires and, at the same time, offers a degree of compression resistance and a flexural stiffness that satisfies the technical requirements.

The object is solved by a composite wire comprising a thermoplastic monofilament as a core component and a sheath which sheath comprises at least two groups of reinforcement threads wrapped around the core component characterized in that the at least two groups of reinforcement threads form angles with the core component with the overall sum of all angles being essentially zero.

Throughout the application, the terms “biological sources” and “biological origin” will be used synonymously. Both terms mean that a material is obtained from living organisms such as plants, fungi, bacteria or animals. A typical feature of materials of biological origin is that their carbon content is part of the natural carbon cycle and does not originate from fossil carbon bound in the lithosphere. Typically, upon disposal materials of biological origin do not contribute to an increase of the carbon dioxide content of the atmosphere and thus do not have an impact on the global climate.

Throughout this application, the terms “recycling sources” and “recycled” are used synonymously. Both terms mean that a material is obtained from waste material by chemical and/or physical processing. Physical processing means that waste material is put into a different form which e.g. means that waste thermoplastics, glass or metals are melted and brought into a different form by e.g. extruding, casting or any other process known in the art in order to obtain a new item which is from the same material as the waste which has been physically treated.

Chemical processing means that waste material is treated in order to induce a chemical decomposition to obtain raw materials which can afterwards be processed to the same material as the initial one or to another material.

In general, materials obtained from recycling are neither obtained from living organisms such as materials of biological origin nor from raw materials taken from the lithosphere such as minerals or fossil fuels.

A composite wire according to the application is an object which has a length that is at least hundred times its diameter and which comprises at least two different materials.

The core component can be of any thermoplastic material such as polyesters (polyethylene terephthalate (PET), polytrimethylene terephthalate (PTT), polybutylene terephthalate (PBT), polyethylene naphthalate (PEN), polethylene furanoate (PEF), and the like), aromatic polyesters, aliphatic polyamides (such as polyamide-5, polyamide-6, polyamide-6,6, polyamide-5,6, polyamide-4,10, polyamide-6,10, polyamide-6,8, polyamide-10 or polyamide-11), aromatic polyamides such as aramids (para-polyphenylene terephtalamide, meta-polyphenylene isophthalamide), polyvinyl alcohol, polyvinyl acetate, polyphenylene benzobisoxazole (PBO), polybenzimidazole (PBI), polyetheretherketone (PEEK), ultra high molecular weight polyethylene (UHMWPE), polyurethane (PUR) or copolymers comprising monomers of said materials or mixtures or blends of said materials but is not limited to this selection.

The material of the core component may in part or completely be of biological origin. The material of the core component may in part or completely be made from recycled plastics. Materials of biological and recycling sources may be combined.

In an embodiment, the core component may comprise a nucleating agent. Said nucleating agent may be talc or a similar inorganic filler, sodium benzoate, sodium stearate, sodium-ion ionomers, a sulfonamide compound metal salt or a sulfonimide compound metal salt, mono sodium salt of dicarboxylic acid, and mixtures thereof, as known in the art.

The core component is a monofilament.

The diameter of the core component is at least 0.3 mm. In an embodiment, the diameter of the core component is at least 0.4 mm. In an embodiment, the diameter of the core component is at least 0.6 mm. In an embodiment, the diameter of the core component is at least 0.8 mm. In an embodiment, the diameter of the core component is at least 1.0 mm. In an embodiment, the diameter of the core component is at least 1.2 mm. In an embodiment, the diameter of the core component is at least 1.4 mm. In an embodiment, the diameter of the core component is at least 1.6 mm. In an embodiment, the diameter of the core component is at least 1.8 mm. In an embodiment, the diameter of the core component is at least 2.0 mm. In an embodiment, the diameter of the core component is at least 2.3 mm.

The diameter of the core component is at most 2.5 mm. In an embodiment, the diameter of the core component is at most 2.3 mm. In an embodiment, the diameter of the core component is at most 2.1 mm. In an embodiment, the diameter of the core component is at most 1.9 mm. In an embodiment, the diameter of the core component is at most 1.7 mm. In an embodiment, the diameter of the core component is at most 1.5 mm. In an embodiment, the diameter of the core component is at most 0.9 mm. In an embodiment, the diameter of the core component is at most 0.7 mm. In an embodiment, the diameter of the core component is at most 0.5 mm.

The groups of reinforcement threads may comprise one or more reinforcement threads which are essentially parallel. The expression “group” does not necessarily mean that reinforcement threads of the same group have the same or similar properties and that reinforcement threads of different groups have different properties. Hence, the expression “group” must more be interpreted as a subset of the full set of reinforcement threads comprised in the composite wire according to the invention. The reinforcement threads of one group are processed together.

The reinforcement threads may comprise fibers.

According to the application, the term “fiber” can mean any object that has a length which is at least 100 times its diameter. It is important to notice that, according to this application, the term “fiber” is to be interpreted very broad. That means that also filaments or strings are fibers as understood in this application. Furthermore, the term “fiber” also encompasses metal wires.

The fibers according to the application may have any cross section shape. The cross section of the fibers, encompassing metal wires and filaments, can be round, oval, oblong, triangular, quadratic, rectangular or of any polygonal shape such as pentagonal, hexagonal, heptagonal or octagonal. Also star-shape cross sections are possible.

The reinforcement threads may be monofilaments, yarns or cords.

If the reinforcement threads are yarns, the yarns may be twisted or untwisted. Twisted yarns typically have an essentially round cross section. Twisted yarns may be twisted in S- or in Z-direction. Yarns which are not twisted may also have other cross section geometries such as rectangular, oblong or oval or they may have a ribbon-like shape. The skilled person knows ribbon-like shaped yarns also as “flat yarns” or “ribbon-yarn”. If the reinforcement threads are cords, the cords may be formed from two or more yarns twisted together. In a cord according to the application, the yarns may be twisted by themselves. In a cord of twisted yarns, typically, the yarns have S-twist and they are twisted together in Z-twist or the yarns have Z-twist and are twisted together in S-twist. Cords may also be twisted from e.g. two yarns with one having S-twist and one having Z-twist.

Cords can also be made from untwisted yarns which untwisted yarns are twisted together. A cord may also comprise both twisted and untwisted yarns or any combination of twisted yarns, untwisted yarns and monofilaments.

The fibers comprised in the reinforcement threads can be of any organic polymer or inorganic material known in the art. Possible inorganic materials are aluminum, steel, glass, carbon or basalt. Possible organic polymers are thermoplastic and/or thermosetting polymers such as polyesters (polyethylene terephthalate (PET), polytrimethylene terephthalate (PTT), polybutylene terephthalate (PBT), polyethylene naphthalate (PEN), polethylene furanoate (PEF), and the like), aromatic polyesters, aliphatic polyamides (such as polyamide-5, polyamide-6, polyamide-6,6, polyamide-5,6, polyimide-4,10, polyamide-6,10, polyimide-6,8, polyamide-10 or polyamide-11), aromatic polyamides such as para-polyphenylene terephthalamide or meta-polyphenylene isophthalamide, polyvinyl alcohol, polyvinyl acetate, polyphenylene benzobisoxazole (PBO), polybenzimidazole (PBI), polyetheretherketone (PEEK), ultra high molecular weight polyethylene (UHMWPE), polyurethane (PUR) or copolymers comprising monomers of said materials or mixtures or blends of said materials but is not limited to this selection. The reinforcement fibers may be comprised in the reinforcement threads in the form of filaments. The material for the reinforcement fibers may completely or in part be of biological origin and/or from recycling sources.

A filament according to the application is a fiber of essentially infinite length. The length of typical filaments is more than a meter; however, a filament can easily have a length of several hundred meters or even several kilometers.

In case one single filament is handled, transported and/or processed alone and not together with other filaments, it is called a monofilament.

Filaments according to the application do not necessarily have to be monolithic objects. Filaments may be hollow or may comprise enclosures such as particulate or fibrous fillers, fibers, yarns, cords or any combination thereof. A filament may thus be a twisted yarn or cord which is dipped, coated, co-extruded or sized in such a way that on its outside, it has a homogeneous surface.

Filaments according to the application may have any cross section geometry known in the art such as round, oblong, quadratic, rectangular, trigonal or polygonic such as pentagonal, hexagonal, heptagonal or octogonal. Also star-shaped or kidney-shaped cross sections are possible. Also a metal wire can be a filament according to the application

It is understood that all characteristics of filaments that have been disclosed here hold true for all kinds of filaments which are relevant in this application.

The filaments may be connected, assembled and/or put together to form yarns. A yarn is an essentially one-dimensional body of fibers wherein the fibers are connected by twisting, welding, adhesive bonding and/or any other connection technique known in the art

A yarn may also be formed by connecting several yarns by twisting, welding, adhesive bonding or any other connection techniques known in the art. Yarns which are formed by twisting yarns together are typically known as cords or twines depending on their thickness and use.

Yarns may have any kind of cross section geometry such as round, oval, trigonal, tetragonal or essentially line-shaped. Essentially line-shaped means that the cross section of the yarn is oval or rectangular with a width that is at least ten times as large as the thickness. Yarns with an essentially line-shaped cross section are known to the skilled person as “flat yarns”, “ribbons”, rovings or “tape yarns”. Flat yarns are typically not formed by twisting yarns and/or fibers together which would lead to an essentially round cross section. However, several twisted yarns may be connected to a flat yarn. In typical flat yarns the fibers are either connected by an adhesive or they are embedded into a matrix material.

In a composite wire according to the invention, two, four, six, eight or more groups of reinforcement threads are wrapped around the core component. The number of groups of reinforcement threads may be any even number.

According to the application, “wrapping” means that the groups of reinforcement threads are arranged around the core component. The groups of reinforcement threads form an angle with a line perpendicular to the core component. This angle is called the “wrapping angle”. According to the application, the wrapping angle is positive if it describes a clockwise rotation from the group of reinforcement threads to the core component and it is negative if it describes a counterclockwise rotation from the group of reinforcement threads to the core component.

Every group of reinforcement threads forms a wrapping angle of at least ±15 degrees. In an embodiment, the wrapping angle is at least ±23 degrees. In an embodiment, the wrapping angle is at least ±30 degrees. In an embodiment, the wrapping angle is at least ±40 degrees.

Every group of reinforcement threads forms a wrapping angle of at most ±85 degrees. In an embodiment, the wrapping angle is at most ±70 degrees. In an embodiment, the wrapping angle is at most ±60 degrees. In an embodiment, the wrapping angle is at most ±50 degrees.

The overall sum of the wrapping angles of all groups of reinforcement threads is essentially zero. Essentially zero, as used herein, means that the overall sum of the wrapping angles of all groups of reinforcement threads is at most ±9 degrees. In an embodiment, the overall sum of the wrapping angles of all groups of reinforcement threads is at most ±5 or ±1 degrees.

In an embodiment, the groups of reinforcement threads are wrapped around the core component in at least 70 turns per meter (tpm). In an embodiment, the groups of reinforcement threads are wrapped around the core component in at least 270 tpm. In an embodiment, the groups of reinforcement threads are wrapped around the core component in at least 1000 tpm. In an embodiment, the groups of reinforcement threads are wrapped around the core component in at least 5000 tpm. In an embodiment, the groups of reinforcement threads are wrapped around the core in at least 7000 tpm. In an embodiment, the groups of reinforcement threads are wrapped around the core in at least 10000 tpm.

In an embodiment, the groups of reinforcement threads are wrapped around the core component in at most 1000 tpm. In an embodiment, the groups of reinforcement threads are wrapped around the core component in at most 5000 tpm. In an embodiment, the groups of reinforcement threads are wrapped around the core component in at most 7000 tpm. In an embodiment, the groups of reinforcement threads are wrapped around the core component in at most 9000 tpm. In an embodiment, the groups of reinforcement threads are wrapped around the core in at most 13000 tpm.

The number of turns n in the wrapping is directly connected to both the wrapping angle α and the diameter d in meters of the core component by the following formula:

$$n = \vert \frac{1}{d * tan α} \vert$$

In an embodiment, wrapping of the groups of reinforcement threads around the core component is carried out by cord twisting. In an embodiment, wrapping of the groups of reinforcement threads around the core component is carried out by cabling.

In an embodiment, at least two groups of reinforcement threads are wound around the core component. According to the application, winding means that each group of reinforcement threads forms an autonomous helix around the core component. In an embodiment, at least two groups of reinforcement threads may be braided around the core component. Braiding means that at least two groups of reinforcement threads form commingled helices around the core component.

According to the application, the term “wrapping” can either mean that a group of threads is wound or braided around the core component. The term “wrapping” furthermore encloses any combination of winding and braiding.

In an embodiment, at least two groups of reinforcement threads are wound around the core component and at least two groups of reinforcement threads are braided around the core component.

In an embodiment, winding and braiding of the groups of reinforcement threads may be combined.

In an embodiment, the core component of the composite wire according to the invention may comprise reinforcement fibers. The reinforcement fibers may be comprised in the core component either in the form of a single filament, of multiple parallel filaments or as a twisted yarn either made of fibers or of yarns being twisted together. The reinforcement fibers comprised in the core component may be the same or different from the reinforcement threads comprised in the sheath of the composite wire. The reinforcement fibers can be of any organic polymer or inorganic material known in the art. Possible inorganic materials may be glass, carbon, basalt, steel or aluminum. Possible organic polymers are all thermoplastic and/or thermosetting polymers such as polyesters (polyethylene terephthalate (PET), polytrimethylene terephthalate (PTT), polybutylene terephthalate (PBT), polyethylene naphthalate (PEN), polethylene furanoate (PEF), and the like), aromatic polyesters, aliphatic polyamides (such as polyamide-5, polyamide-6, polyimide-6,6, polyamide-5,6, polyimide-4,10, polyamide-6,10, polyimide-6,8, polyimide-10 or polyimide-11), aromatic polyamides such as para-polyphenylene terephthalamide or meta-polyphenylene isophthalamide, polyvinyl alcohol, polyvinyl acetate, polyphenylene benzobisoxazole (PBO), polybenzimidazole (PBI), polyetheretherketone (PEEK), ultra high molecular weight polyethylene (UHMWPE), polyurethane (PUR) or copolymers comprising monomers of said materials or mixtures or blends of said materials but is not limited to this selection. The material of the reinforcement fibers may be in total or in part from biological and/or recycling sources.

In an embodiment, the reinforcement fibers are embedded in the thermoplastic material using the coextrusion technique. In case the core component comprises reinforcement fibers, the core component comprises at least 23 Vol-% of reinforcement fibers based on the total volume of the core component. In an embodiment, the core component comprises at least 29 Vol.-% of reinforcement fibers based on the total volume of the core component.

The core component comprises at most 50 Vol.-% of reinforcement fibers based on the total volume of the core component. In an embodiment, the core component comprises at most 45 Vol.-% of reinforcement fibers based on the total volume of the core component.

In an embodiment, the reinforcement fibers are located in the center of the core component as a single filament or metal wire or as multiple fibers, filaments or metal wires forming a fiber bundle, a yarn or a cord. The reinforcement fibers may be treated with any kind of sizing known to the skilled person such as binders or bonding agents. Important bonding agents are e.g. known by the skilled person as resorcinol-formaldehyde-latex-(RFL)-dip. Also other bonding agents are known based on other chemicals.

The composite wire according to the application may be comprised in a broad variety of products e.g. for reinforcement of elastomeric articles such as tires. A composite wire according to the invention may thus be embedded into an elastomeric material.

A composite wire according to the invention may furthermore be twisted together with other composite wires or yarns to form a reinforcement yarn or cord to be embedded into an elastomeric material. A composite wire according to the invention or any yarns or cords comprising such composite wire may be woven, knitted or braided to one- or two-dimensional reinforcement structures to be embedded into an elastomeric material.

The composite wire or any one-dimensional or two-dimensional structure made thereof may be surface-treated to improve adhesion to rubber. Surface treatments for this purpose are known to the skilled person as “dippings” and are typically carried out using mixtures of resorcinol, formaldehyde and latex (so-called RFL-dip) or acrylate polymers. Also, other dippings free of resorcinol and formaldehyde known by the skilled person are possible.

The dipping may have an influence on the stiffness of the composite wire.

An elastomeric material is any polymeric material comprising cross-linked polymeric chains and showing significant elasticity. Elastomeric materials may comprise natural rubber, synthetic rubber, chloroprene rubber, styrene-butadiene-rubber, nitrile rubber or butyl rubber as well as silicone rubber, fluorosilicone rubber, fluoroelastomers or phosphazene elastomers or mixtures thereof. Products made of reinforced elastomeric materials are, but not limited to, tires, hoses, driving belts, conveyor belts or sealings under strong mechanical stress. Composite wires according to the application may be comprised in a broad variety of reinforcement structures.

The application also pertains to a reinforcement belt for a pneumatic or non-pneumatic vehicle or airplane tire comprising at least one composite wire according to the application. A reinforcement belt is typically a structure of cords rubberized together and located between the cap-ply and the reinforcement carcass of a tire. The composite wire may be contained in the belt as a single composite wire or as part of a yarn or cord together either with further composite wires according to the application or together with fibers, yarns or cords from different materials. In the belt the composite wire may be part of a woven, knitted or braided reinforcement material. The composite yarn according to the application may further be comprised in the bead reinforcement, in the cap-ply or in the carcass of a tire.

The application also pertains to a bead reinforcement for a pneumatic or non-pneumatic vehicle or airplane tire comprising at least one composite wire according to the application. The bead reinforcement is located in the tire bead area. The bead reinforcement may comprise the composite wire according to the application either as a single composite wire or as a bundle of composite wires which bundle may contain either only composite wires according to the application or composite wires according to the application together with yarns or cords made from other materials. Bead reinforcements are known by the skilled person also under the expressions “chafer” or “flipper”.

The application also pertains to a reinforcement carcass for a pneumatic or non-pneumatic vehicle or airplane tire comprising at least one composite wire according to the application. The reinforcement carcass typically comprises one or more woven layers made of cords. The layers of the carcass may either be arranged radially (so-called “radial tires”) or cross-plied at opposing angles (so-called “bias tires”). The composite wire may be contained in the carcass as a single composite wire or as part of a yarn or cord together either with further composite wires according to the application or together with fibers, yarns or cords from different materials. In the carcass, the composite wire may be part of a woven, knitted or braided reinforcement material.

The application also pertains to a cap-ply for a pneumatic or non-pneumatic vehicle or airplane tire comprising at least one composite wire according to the application. The cap-ply typically comprises cords which are located underneath the tread of the tire which are typically oriented in the rolling direction of the tire. The composite wire may be contained in the cap-ply as a single composite wire or as part of a yarn or cord together either with further composite wires according to the application or together with fibers, yarns or cords from different materials. In the cap-ply the composite wire may be part of a woven, knitted or braided reinforcement material.

The application also pertains to a pneumatic or non-pneumatic vehicle or airplane tire comprising at least one composite wire according to the application.

In an embodiment, the tire may comprise a bead reinforcement according to the application. In an embodiment, the bead reinforcement of the application is a flipper. In an embodiment, the bead reinforcement of the application is a chafer. In an embodiment, the tire comprises a reinforcement carcass according to the application.

In an embodiment, the tire comprises a cap-ply according to the application.

In an embodiment, the tire comprises a belt according to the application.

It has surprisingly been found that the amount of steel in a tire according to the application can be reduced even more if it further comprises at least one thermoplastic string with embedded reinforcement fibers in the bead reinforcement.

The thermoplastic string according to the application may also replace the composite wire according to the application in any application in tires or elsewhere.

According to the application, a string is an elongated body of cylindrical or prismatic shape with a circular, elliptic, oblong, trigonal, quadratic, rectangular, pentagonal, hexagonal, heptagonal, octagonal or other polygonal cross section. The largest diameter of a string according to the application is at most a tenth of the length of the string. In typical cases, the length of a string according to the application is at least several thousand times the largest diameter. A string according to the application is a homogeneous body which means that at least regarding its outside the string is monolithic. However, this does not mean that a string according to the application must not comprise smaller parts or fragments such as fibers, filaments or particles, however said smaller parts or fragments are essentially entirely covered in such a way that to its outside the string is one part. In an embodiment, the thermoplastic string has the shape of a filament. The diameter of the thermoplastic string is at least 0.3 mm. In an embodiment, the diameter of the thermoplastic string is at least 0.4 mm. In an embodiment, the diameter of the thermoplastic string is at least 0.6 mm. In an embodiment, the diameter of the thermoplastic string is at least 0.8 mm. In an embodiment, the diameter of the thermoplastic string is at least 1.0 mm. In an embodiment, the diameter of the thermoplastic string is at least 1.2 mm. In an embodiment, the diameter of the thermoplastic string is at least 1.4 mm. In an embodiment, the diameter of the thermoplastic string is at least 1.6 mm. In an embodiment, the diameter of the thermoplastic string is at least 1.8 mm. In an embodiment, the diameter of the thermoplastic string is at least 2.0 mm. In an embodiment, the diameter of the thermoplastic string is at least 2.3 mm.

The diameter of the thermoplastic string is at most 2.5 mm. In an embodiment, the diameter of the thermoplastic string is at most 2.3 mm. In an embodiment, the diameter of the thermoplastic string is at most 2.1 mm. In an embodiment, the diameter of the thermoplastic string is at most 1.9 mm. In an embodiment, the diameter of the thermoplastic string is at most 1.7 mm. In an embodiment, the diameter of the thermoplastic string is at most 1.5 mm. In an embodiment, the diameter of the thermoplastic string is at most 1.2 mm. In an embodiment, the diameter of the thermoplastic string is at most 0.9 mm. In an embodiment, the diameter of the thermoplastic string is at most 0.7 mm. In an embodiment, the diameter of the thermoplastic string is at most 0.5 mm.

The thermoplastic string can be of any thermoplastic or thermosetting material. Possible organic polymers are all thermoplastic and/or thermosetting polymers such as polyesters (polyethylene terephthalate (PET), polytrimethylene terephthalate (PTT), polybutylene terephthalate (PBT), polyethylene naphthalate (PEN), polethylene furanoate (PEF), and the like), aromatic polyesters, aliphatic polyamides (such as polyamide-5, polyamide-6, polyamide-6,6, polyamide-5,6, polyamide-4,10, polyamide-6,10, polyamide-6,8, polyamide-10 or polyamide-11), aromatic polyamides such as para-polyphenylene terephthalamide or meta-polyphenylene isophthalamide, polyvinyl alcohol, polyvinyl acetate, polyphenylene benzobisoxazole (PBO), polybenzimidazole (PBI), polyetheretherketone (PEEK), ultra high molecular weight polyethylene (UHMWPE), polyurethane (PUR) or copolymers comprising monomers of said materials or mixtures or blends thereof of said materials but is not limited to this selection. The material of the thermoplastic string may be in total or in part from biological and/or recycling sources.

The reinforcement fibers can be any kind or organic polymer or inorganic material known in the art. Possible inorganic materials are glass, carbon, basalt, steel or aluminium. Possible organic polymers are polyethylene terephthalate (PET), polyethylene naphthalate (PEN), cellulosic filaments such as rayon or lyocell, polyvinyl alcohol, polyvinyl acetate, aliphatic polyamides such as polyamide-5, polyamide-6, polyimide-6,6, polyimide-5,6, polyamide-5,10, polyimide-4,10, polyamide-6,10, polyamide-6,8, polyamide-10 or polyamide-11, aromatic polyamides such as para-polyphenylene terephthalamide or meta-polyphenylene isophthalamide, proteinous fibers like silk, polyphenylene benzobisoxazole (PBC)), ultra high molecular weight polyethylene (UHMWPE) or aromatic polyesters or mixtures thereof. The material of the reinforcement fibers may be in total or in part from biological and/or recycling sources“.

The thermoplastic string may comprise the same or different reinforcement fibers as the sheath of” the composite wire according to the application. The thermoplastic string may comprise the same or different reinforcement fibers as the core component of the composite wire according to the application.

The reinforcement fibers may be comprised in the thermoplastic string either in the form of a single filament, multiple parallel filaments or as a twisted yarn or cord. In an embodiment, the reinforcement fibers are embedded in the thermoplastic material using the coextrusion technique. The thermoplastic string comprises at least 23 Vol.-% of reinforcement fibers based on the total mass of the thermoplastic string. In an embodiment, the thermoplastic string comprises at least 29 Vol.-% of reinforcement fibers based on the total mass of the thermoplastic string.

The thermoplastic string comprises at most 50 Vol.-% of reinforcement fibers based on the total mass of the thermoplastic string. In an embodiment, the thermoplastic string comprises at most 45 Vol.-% of reinforcement fibers based on the total mass of the thermoplastic string. The reinforcement fibers may be treated with any kind of sizing known to the skilled person such as binders or bonding agents. Important bonding agents are e.g. known by the skilled person as resorcinol-formaldehyde-latex-(RFL)-dip. Also other bonding agents are known based on other chemicals.

In an embodiment, the reinforcement fibers are located in the center of the thermoplastic string.

The thermoplastic string may be comprised in the bead reinforcement alone or together with composite wires according to the application and/or together with cords, thread or yarns from the same or different materials. The thermoplastic string may be comprised in the bead reinforcement twisted or cabled together with other thermoplastic strings and/or twisted or cabled together with composite wires according to the application and/or twisted or cabled together with cords, threads or yarns from the same or different materials.

### EXAMPLES

In all examples, stiffness measurements have been carried out according to section 38 of ASTM D885 with the variation that only one cord has been tested instead of a sample made by 10 cords.

Stiffness results indicated for every variant are the average results of 3 measurements.

### Comparative Examples

In order to provide a measure for the stiffness of the composite wire according to the application, typical steel wires and cords used in tire reinforcements are provided as reference in Tab. 1.

TABLE 1
Abbreviations: NT—Normal tensile, steel with carbon content
up to 0.7%, HT—High tensile, steel with carbon content
of up to 0.8%; ST—Super high tensile, steel with carbon
content of up to 0.9%; UT—Ultra high tensile, steel with
carbon content of up to 0.96%. “2 × 0.28 ST”
means that two steel wires of 0.28 mm and HT grade have been
twisted together. “2 + 1 × 0.22 HT” means
that first two wires of 0.22 mm thickness and HT grade have
been twisted together and that the obtained cord is twisted
with one further wire of 0.22 mm thickness and HT grade.

| | stiffness | Weight | Diameter |
|---|---|---|---|
| Construction | [cN] | [dtex] | [mm] |
| 0.22 HT | 275 | 29 | 0.22 |
| 0.25 HT | 425 | 37 | 0.25 |
| 0.28 ST | 668 | 46 | 0.28 |
| 0.30 UT | 859 | 53 | 0.3 |
| 2 × 0.28 ST | 1247 | 96 | 0.56 |
| 2 × 0.30 UT | 1578 | 110 | 0.6 |
| 2 × 0.30 ST | 1297 | 110 | 0.6 |
| 2 + 1 × 0.22 HT | 796 | 90 | 0.55 |
| 2 + 1 × 0.28 NT | 1795 | 145 | 0.7 |
| 2 + 2 × 0.25 NT | 1359 | 155 | 0.65 |

From Tab. 1, it is easily seen that typical steel cords easily achieve stiffnesses of up to nearly 1800 cN.

### Examples

In a series of tests, the stiffness data for several composite wires according to the application have been tested. In Tab. 2, the values for 18 samples are listed.

TABLE 2
Composite wires obtained from steel wire of the grade indicated with variable
thickness (in mm, number after slash) embedded into a PET monofilament with
variable thickness (number before slash) as core component wound with two
groups of either nylon (NY) or PET yarns of variable linear density (third
number). All core components are wound by two yarns of the stated linear density.
The Nylon yarns of 940 and 1400 dtex consist of 140 or 210 filaments, respectively.
The PET yarns of 1100 and 1670 dtex consist of 300 or 446 filaments, respectively.
All composite wires apart from the ones marked ¹ have been dipped using
the well-established RFL-dipping procedure.

| | | | stiffness | Weight | Diameter |
|---|---|---|---|---|---|
| No. | Construction | tpm | [cN] | [dtex] | [mm] |
| 1 | PET/Steel 0.65/0.22HT NY940 | 200 | 568 | 87.94 | 0.9 |
| 2 | PET/Steel 0.65/0.22HT NY1400 | 200 | 589 | 100.87 | 1.01 |
| 3 | PET/Steel 0.65/0.25NT NY940 | 200 | 737 | 96.25 | 0.99 |
| 4 | PET/Steel 0.65/0.25NT NY1400 | 200 | 767 | 106.05 | 1.01 |
| 5 | PET/Steel 0.70/0.28ST NY940 | 200 | 1050 | 105.59 | 0.95 |
| 6 | PET/Steel 0.70/0.28ST NY1400 | 200 | 1171 | 120.07 | 1.03 |
| 7 | PET/Steel 0.73/0.30UT NY940 | 200 | 1276 | 123.76 | 1.02 |
| 8 | PET/Steel 0.73/0.30UT NY1400 | 200 | 1362 | 135.99 | 1.15 |
| 9 | PET/Steel 0.73/0.30UT NY1400¹ | 200 | 1154 | 133.30 | 1.19 |
| 10 | PET/Steel 0.73/0.30UT NY1400 | 100 | 1451 | 135.32 | 1.13 |
| 11 | PET/Steel 0.65/0.22HT PET1100 | 200 | 648 | 91.58 | 1.02 |
| 12 | PET/Steel 0.65/0.22HT PET1670 | 200 | 690 | 106.57 | 1.07 |
| 13 | PET/Steel 0.65/0.25HT PET1100 | 200 | 841 | 99.37 | 1.11 |
| 14 | PET/Steel 0.65/0.25HT PET1670 | 200 | 925 | 114.61 | 1.08 |
| 15 | PET/Steel 0.70/0.28ST PET1100 | 200 | 1105 | 111.19 | 1.11 |
| 16 | PET/Steel 0.70/0.28ST PET1670 | 200 | 1172 | 124.86 | 1.11 |
| 17 | PET/Steel 0.73/0.30ST PET1100 | 200 | 1304 | 129.76 | 1.1 |
| 18 | PET/Steel 0.73/0.30ST PET1670 | 200 | 1406 | 144.07 | 1.2 |

From Tab. 2 can be seen that the RFL dip, which is neither necessary nor possible for steel wires has a significant influence on the stiffness of the composite wire.

Table 3 shows four examples for thermoplastic strings according to the application wherein a steel monofilament of the mentioned grade with variable thickness (in mm, number after slash) embedded into a PET monofilament with variable thickness (number before slash).

| | | stiffness | Weight | Diameter |
|---|---|---|---|---|
| No. | Construction | [cN] | [dtex] | [mm] |
| 19 | PET/Steel 0.65/0.22HT | 438 | 64.8 | 0.65 |
| 20 | PET/Steel 0.65/0.25HT | 581 | 70.9 | 0.65 |
| 21 | PET/Steel 0.70/0.28ST | 877 | 82.7 | 0.7 |
| 22 | PET/Steel 0.73/0.30UT | 1116 | 100.4 | 0.73 |

TABLE 4
Composite wires consisting of a PET core (without reinforcement
fibers within the core) of variable thickness in millimeters
(number before the slash) and wound by two strands of aramid filaments
with a linear density in dtex (number after the slash). All composite
wires apart from the ones marked ¹ have been dipped using the
well-established RFL-dipping procedure. The aramid yarns consisted
of 500 and 1000 filaments, respectively.

| | | | stiffness | Weight | Diameter |
|---|---|---|---|---|---|
| No. | Construction | tpm | [cN] | [dtex] | [mm] |
| 23 | PET/AR 0.3/840 | 200 | 45 | 27.22 | 0.47 |
| 24 | PET/AR 0.3/840 | 250 | 43 | 27.57 | 0.5 |
| 25 | PET/AR 0.3/1100 | 200 | 50 | 33.6 | 0.49 |
| 26 | PET/AR 0.3/1100 | 250 | 44 | 33.82 | 0.52 |
| 27 | PET/AR 0.3/1680 | 200 | 55 | 46.98 | 0.71 |
| 28 | PET/AR 0.3/1680 | 250 | 55 | 47.48 | 0.76 |
| 29 | PET/AR 0.4/840 | 200 | 108 | 35.56 | 0.55 |
| 30 | PET/AR 0.4/840 | 250 | 104 | 35.68 | 0.58 |
| 31 | PET/AR 0.4/1680 | 200 | 118 | 55.58 | 0.74 |
| 32 | PET/AR 0.4/1680 | 250 | 114 | 56.71 | 0.77 |
| 33 | PET/AR 0.65/840 | 200 | 467 | 66.18 | 0.83 |
| 34 | PET/AR 0.65/840 | 250 | 481 | 67.16 | 0.87 |
| 35 | PET/AR 0.65/1680 | 200 | 482 | 87.77 | 0.94 |
| 36 | PET/AR 0.65/1680 | 250 | 477 | 90.36 | 0.96 |
| 37 | PET/AR 0.65/1680¹ | 200 | 383 | 85.36 | 0.96 |

The results shown in Tab. 4 once again indicate that the winding number has an influence on the stiffness measured for the composite wires. Furthermore, comparison between examples No. 35 and 37 again shows the influence of the dipping on the stiffness obtained.

### DESCRIPTION OF FIGURES

The figures show two embodiments of the composite wire according to the application as well as the wrapping angle.

FIG. 1 shows a part of a composite wire according to the application with a core component 1 and two groups of reinforcement threads 2 being wrapped or braided around the core component. The figure shows the definition of 0° and 90° for the wrapping angle α as well as the diameter of the core component d. The distance between two windings, the so-called wrapping pitch, is called a.

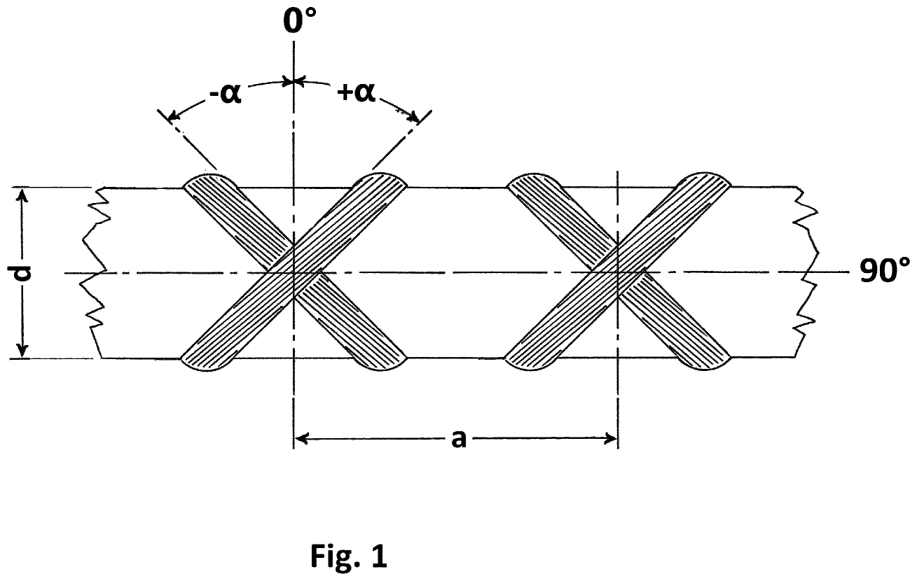

FIG. 2 shows an embodiment of the composite wire according to the application with a core component 1 and two groups of reinforcement threads 2 being wrapped around the core component. The core component comprises reinforcement fibers 3.

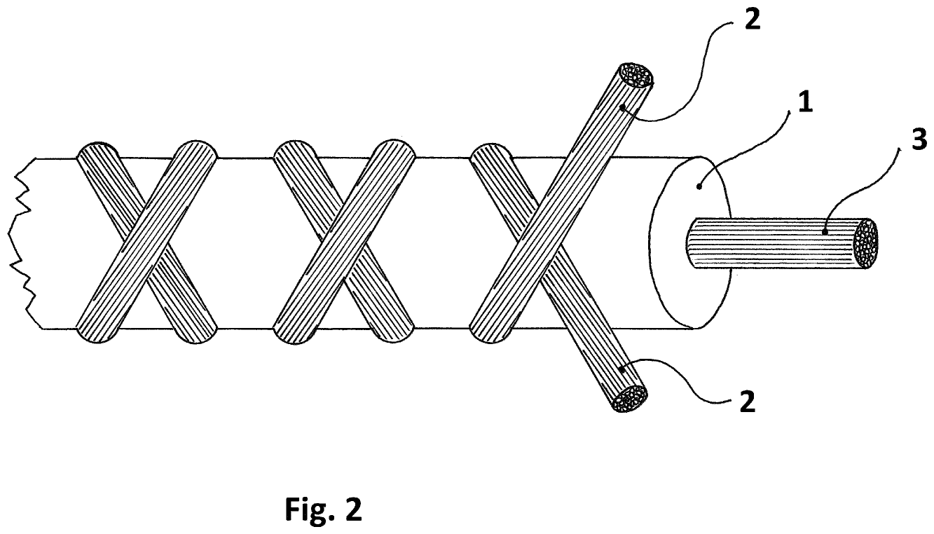

FIG. 3 shows and embodiment of the composite wire according to the application with a core component 1 and two groups of reinforcement threads 2 being braided around the core component. The core component comprises reinforcement fibers 3.

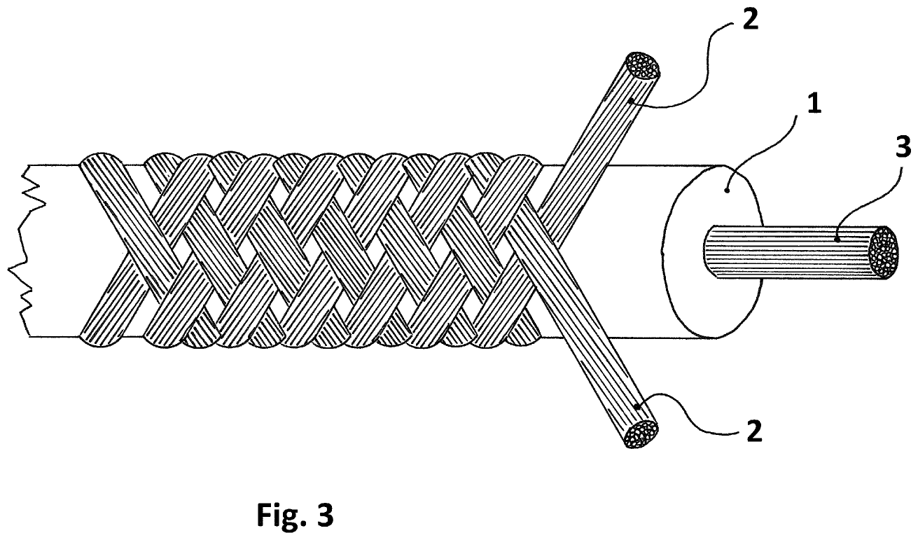

1. A composite wire comprising a thermoplastic monofilament as a core component and a sheath, the sheath comprises at least two groups of reinforcement threads (wrapped around the core component wherein the at least two groups of reinforcement threads form angles with the core component with the overall sum of all angles being substantially zero.

2. The composite wire of claim 1, wherein the core component has a thickness of at least 0.3 and at most 1.2 mm.

3. The composite wire of claim 1, wherein the core component comprises a nucleating agent, the nucleating agent being talc or a similar inorganic filler, sodium benzoate, sodium stearate, sodium-ion ionomers, a sulfonamide compound metal salt or a sulfonimide compound metal salt, mono sodium salt of dicarboxylic acid, or any mixture thereof.

4. The composite wire of claim 1, wherein at least two groups of reinforcement threads are wrapped around the core component.

5. The composite wire of claim 1, wherein at least two groups of reinforcement threads are wound around the core component and/or at least two groups of reinforcement threads are braided around the core component.

6. The composite wire of claim 1, wherein the core component forms an angle of at least ±15 degrees with every group of reinforcement threads.

7. The composite wire of claim 1, wherein the core component comprises reinforcement fibers.

8. The composite wire of claim 1, wherein the reinforcement fibers are comprised in the core component as at least one fiber bundle, yarn or cord.

9. The composite wire of claim 7, wherein the reinforcement fibers in the core component comprise a monofilament.

10. The composite wire of claim 7, wherein the reinforcement fibers comprise glass, carbon fibers, steel wire, aluminum wire, polyethylene terephthalate, polyethylene naphthalate, polyvinyl acetate, cellulose filaments, polyvinyl alcohol, polyvinyl acetate, polyamide-5, polyamide-6, polyamide-5,6, polyamide-5,10, polyamide-6,6, polyamide-4,10, polyamide-6,10, polyamide-6,8, polyamide or polyamide-11, proteinous fibers, aromatic polyamides, polyphenylene benzobisoxazole, ultra high molecular weight polyethylene or aromatic polyesters or copolymers comprising monomers of said materials or mixtures of said materials.

11. The composite wire of claim 10, wherein the materials comprised in the reinforcement fibers are in part or in total biological and/or recycled materials.

12. The composite wire of claim 1, wherein the core component comprises polyethylene terephthalate, polytrimethylen terephthalate, polybutylene terephthalate, polyethylene naphthalate aromatic polyesters, aromatic polyamides comprising para-polyphenylene terephthalamide or meta polyphenylene isophthalamide, polyvinyl alcohol, polyvinyl acetate, polyphenylene benzobisoxazole, polyamide-5, polyamide-6, polyamide-6,6, polyamide-5,6, polyamide-4,10, polyamide-6,10, polyamide-6,8, polyamide or polyamide-11, ultra high molecular weight polyethylene, polyurethane or polyetheretherketone, copolymers comprising monomers of said materials or mixtures of said materials.

13. The composite wire of claim 12, wherein the materials comprised in the core component are in part or in total biological and/or recycled materials.

14. The composite wire of claim 1, wherein the reinforcement threads comprise glass, carbon fibers, steel wire, aluminum wire, polyethylene terephthalate, polyethylene naphthalate, polyvinyl acetate, cellulose filaments, polyvinyl alcohol, polyvinyl acetate, polyamide-5, polyamide-6, polyamide-5,6, polyamide-5,10, polyamide-6,6, polyamide-4,10, polyamide-6,10, polyamide-6,8, polyamide or polyamide-11, proteinous fibers, aromatic polyamides, polyphenylene benzobisoxazole, ultra high molecular weight polyethylene or aromatic polyesters or copolymers comprising monomers of said materials or mixtures of said materials.

15. The composite wire of claim 14, wherein the materials comprised in the reinforcement threads are in part or in total biological and/or recycled materials.

16. A reinforcement belt for a pneumatic vehicle tire comprising at least one composite wire of claim 1.

17. A bead reinforcement for a pneumatic car tire comprising at least one composite wire of claim 1.

18. A reinforcement body for a pneumatic vehicle tire comprising at least one composite wire of claim 1.

19. A cap-ply for a pneumatic vehicle tire comprising at least one composite wire of claim 1.

20. A pneumatic vehicle tire comprising at least one composite wire of claim 1.

21. A tire of claim 20, comprising a bead chafer or bead flipper reinforcement element comprising at least one string with embedded reinforcement fibers.

22. A thermoplastic string comprising a thermoplastic monofilament with embedded reinforcement fibers.
